(19) United States
(12) Patent Application Publication
(10) Pub. No.: US 2024/0391823 A1
(43) Pub. Date: Nov. 28, 2024

(54) METHODS OF FORMING ANTI-GLARE SURFACE STRUCTURE WITH CO-LOCATED REFRACTIVE INDEX CONTRAST IN GLASS SUBSTRATES USING GAS LASERS AND ANTI-GLARE LIGHT-TRANSMITTING STRUCTURES WITH LOW SPARKLE AND LOW DISTINCTINESS-OF-IMAGE FORMED FROM SUCH METHODS

(71) Applicant: CORNING INCORPORATED, CORNING, NY (US)

(72) Inventors: Jonathan Thomas Beall, Corning, NY (US); Nikolaus Jon Deems, Elmira, NY (US); Yuhui Jin, Painted Post, NY (US); Xinghua Li, Horseheads, NY (US); Ying Liu, Kennett Square, PA (US); Lei Yuan, Painted Post, NY (US); Liying Zhang, Painted Post, NY (US)

(21) Appl. No.: 18/665,998

(22) Filed: May 16, 2024

Related U.S. Application Data
(60) Provisional application No. 63/468,048, filed on May 22, 2023.

(51) Int. Cl. C03C 17/25; C03C 17/02; C03C 17/28; G02B 5/02

(52) U.S. Cl. CPC C03C 17/253; C03C 17/02; C03C 17/256; C03C 17/28; G02B 5/0226; C03C 2217/211; C03C 2217/212; C03C 2217/213; C03C 2217/214; C03C 2217/218; C03C 2217/22; C03C 2217/228; C03C 2217/23; C03C 2217/42; C03C 2217/732; C03C 2218/114; C03C 2218/32

(57) ABSTRACT

A light-transmitting structure is disclosed. The light-transmitting structure includes a glass-based substrate that has a first major surface and a second major surface opposite the first major surface. The glass-based substrate comprises a first composition that is transparent and has a first refractive index n₁. The light-transmitting structure further includes a plurality of surface regions fused with the glass-based substrate to define a light-scattering surface interposed with the first major surface. Each surface region comprises a second composition that is transparent and has a second refractive index n₂ that is different than the first refractive index n₁. The first major surface and the light-scattering surface define an interface to an ambient environment.

### CROSS-REFERENCE TO RELATED APPLICATIONS

This application claims the benefit of priority under 35 U.S.C. § 119 of U.S. Provisional Application No. 63/468,048 filed May 22, 2023, the content of which is incorporated herein by reference in its entirety.

### FIELD

The present disclosure relates to light-transmitting structures with anti-glare (AG) properties and, more particularly, to methods of forming AG surface structure with co-located refractive index contrast in glass substrates using gas lasers and AG light-transmitting structures with low sparkle and low distinctness-of-image formed from such methods.

### BACKGROUND

Portable electronic devices, such handheld devices (e.g., smartphones, tablets, etc.) and wearable devices (e.g., watches, fitness trackers, etc.), utilize glass-based materials. For example, cover glass or screens on such portable electronic devices can be made of glass-based materials. Optical properties associated with good viewing of the screen are generally sought. Mechanical properties intended to prevent or mitigate optical or structural issues from scratches, impact events (e.g., from drops), excessive flexure, or the like are also desired. Coatings or other surface treatments can be used to enhance glass-based materials. However, current glass-based materials have optical and/or mechanical limitations.

Accordingly, a need exists for glass-based materials with different optical and mechanical characteristics, and methods of producing such materials. This need and other needs are addressed by the present disclosure.

### SUMMARY

A first aspect of the present disclosure includes a light-transmitting structure, comprising: a glass-based substrate having a first major surface and a second major surface opposite the first major surface, the glass-based substrate comprising a first composition that is transparent and has a first refractive index n₁; and a plurality of surface regions fused with the glass-based substrate to define a light-scattering surface interposed with the first major surface, each surface region comprising a second composition that is transparent and has a second refractive index n₂ that is different than the first refractive index n₁, the first major surface and the light-scattering surface defining an interface to an ambient environment.

A second aspect of the present disclosure includes a method for forming a light-transmitting structure, comprising: applying a coating comprising a plurality of particles to a first major surface of a glass-based substrate, the glass-based substrate comprising a first composition that is transparent and has a first refractive index n₁, the particles each comprising a second composition that is transparent and has a second refractive index n₂ that is different than the first refractive index n₁; and irradiating the coating and the glass-based substrate with a beam from a laser to fuse the particles with the glass-based substrate, the fused particles forming a plurality of surface regions configured to define a light-scattering surface interposed with the first major surface, the first major surface and the light-scattering surface defining an interface to an ambient environment.

### BRIEF DESCRIPTION OF THE DRAWINGS

FIG. 1 schematically depicts a cross-sectional view of a light-transmitting structure formed from a glass-based substrate with a substrate surface;

FIG. 2 is a conceptual top-down view of a light-transmitting structure with an ordered pattern of surface regions fused with the glass-based substrate;

FIG. 3 is a conceptual top-down view of a light-transmitting structure with a random pattern of surface regions fused with the glass-based substrate;

FIG. 4. is a schematic cross-sectional view through a textured portion of the light-transmitting structure of FIG. 1 showing the surface regions as domed surface regions fused with the glass-based substrate to define a light-scattering surface interposed with the substrate surface;

FIG. 5 is a simplified view of the light-scattering surface and the substrate surface of FIG. 4 forming a substrate-environment interface comprising peaks and valleys, the domed surface regions configured to define the peaks;

FIG. 6. is a schematic cross-sectional view through a textured portion of the light-transmitting structure of FIG. 1 with collapsed surface regions fused with the glass-based substrate to define a light-scattering surface interposed with the substrate surface;

FIG. 7 is a simplified view of the light-scattering surface and the substrate surface of FIG. 6 forming a substrate-environment interface comprising peaks and valleys, the collapsed surface regions configured to define the valleys;

FIG. 8A is a plan view of an exemplary electronic device incorporating a light-transmitting structure;

FIG. 8B is a perspective view of the exemplary electronic device of FIG. 8A;

FIG. 9 are a scanning electron microscope (SEM) image and associated energy dispersive spectrometry (EDS) elemental mapping images of a portion of a coating/substrate sample that has been laser processed in accordance with Example 3;

FIG. 10 is a backscattered electron (BSE) image of a cross section of the coating/substrate sample described with reference to FIG. 9;

FIG. 11 is an enlarged view of the area indicated in FIG. 10;

FIG. 12 are EDS elemental mapping images of the area shown in FIG. 11;

FIG. 13 is a BSE image of a cross section of a coating/substrate sample that has been laser processed in accordance with Example 4 showing formation of domed surface regions;

FIG. 14 is a BSE image of a cross section of a coating/substrate sample that has been laser processed in accordance with Example 5 showing formation of a collapsed surface region; and

FIG. 15 are EDS elemental mapping images of the area proximate the collapsed surface region shown in FIG. 14 (left) and a chart plotting the elemental concentrations associated with the respective EDS images (right).

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

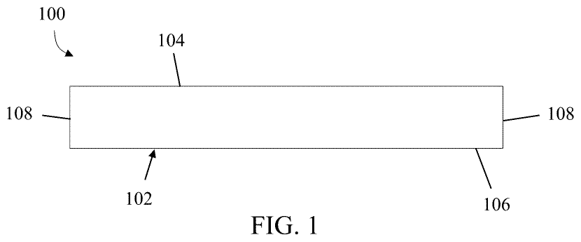

Referring now to FIG. 1, a light-transmitting structure 100 is schematically depicted. The light-transmitting structure 100 comprises a glass-based substrate 102. The glass-based substrate 102 comprises a first composition that is transparent and has a first refractive index n₁. In embodiments, the first composition is a glass or glass ceramic composition. The glass-based substrate 102 can have a first major surface 104 and a second major surface 106 opposite the first major surface 104. The glass-based substrate 102 can also have edges 108 that extend between the first major surface 104 and the second major surface 106. In embodiments, the first major surface 104 and the second major surface 106 can be generally planar and parallel as shown in FIG. 1. In embodiments, the first major surface 104 and the second major surface 106 can be curved and/or not parallel (not shown).

Substrate surfaces with conventional antiglare (AG) texture may have low sparkle or low distinctness-of-image (DOI), but usually not both. In contrast, the light-transmitting structure 100 of the present disclosure includes features configured to give the surfaces of the glass-based substrate 102 an AG texture that possesses both low sparkle and low DOI. Throughout this disclosure, surfaces, substrates, and/or structures that include such features can include the modifier “textured” and be referred to as a textured surface, a textured substrate, and/or a textured structure, respectively. In embodiments, a portion of the first major surface 104 can be textured. In embodiments, the textured portion of the first major surface 104 can cover an entirety of the first major surface 104. In embodiments, a portion of the first major surface 104 and a portion of the second major surface 106 can be textured. In embodiments, an entirety of the first major surface 104 and an entirety of the second major surface 106 can be textured. In embodiments, the edges 106 can additionally or alternatively be textured.

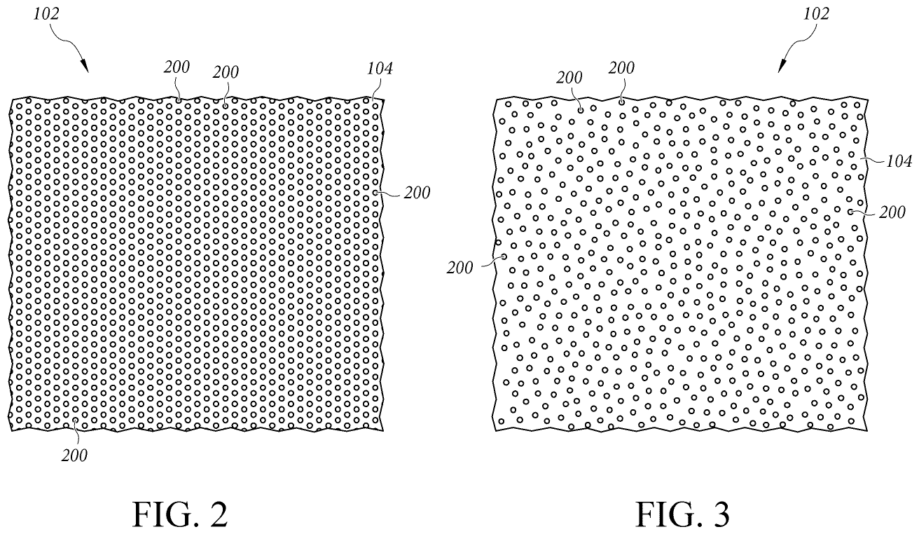

Referring now to FIGS. 2-7, a textured portion of the first major surface 104 of the light-transmitting structure 100 is depicted in various embodiments. Generally common to all embodiments, the light-transmitting structure 100 comprises a plurality of surface regions 200 fused with the glass-based substrate 102 to define a light-scattering surface 204 interposed with the first major surface 104. The surface regions 200 each comprise a second composition that is transparent and has a second refractive index n₂ that is different than the first refractive index n₁. In embodiments, the second composition can be a glass, a metal, a polymer, or combinations thereof. In embodiments, a minimum difference between the first refractive index n₁ and the second refractive index is greater than or equal to 0.05 (e.g., |n₂−n₁|≥0.050), such as greater than or equal to 0.075, 0.100, 0.150, 0.200, 0.250, 0.300, or more. In embodiments, a maximum difference between the first refractive index n₁ and the second refractive index n₂ is less than or equal to 0.650 (e.g., |n₂−n₁|≤0.650), such as less than or equal to 0.625, 0.600, 0.550, 0.500, 0.450, 0.400, or less.

When used to describe the physical associations of the surface regions 200, the terms “fuse,” “fused,” or the like refer to a microstructural association between the glass-based substrate 102 and the surface regions 200 that is achieved by controlled heating (e.g., via laser irradiation as described hereinbelow) of a volume of the second composition on a surface of the glass-based substrate to promote local melting and/or interdiffusion therebetween. The volume of the second composition can have a variety of forms, such as a plurality of particles, fibers, or otherwise fine solid particulate forming a powder, as described hereinbelow in connection with methods for forming the light-transmitting structure. As used herein, the term “interdiffusion” refers to the energy-driven diffusional exchange of atoms across an interface between at least two materials or compositions that are in contact. Interdiffusion can result in the formation of an interdiffusion layer between the materials. The interdiffusion layer can comprise one or more further compositions (e.g., a composition gradient) that differ from the first composition of the glass-based substrate 102 and the second composition of the surface regions 200.

FIG. 2 and FIG. 3 are conceptual top-down views of the textured portion of the first major surface 104 to illustrate different arrangements of the surface regions 200. In embodiments, the surface regions 200 can be fused with the glass-substrate 102 in an ordered pattern as shown in FIG. 2. In embodiments, the surface regions 200 can be fused with the glass-based substrate 102 in a random pattern as shown in FIG. 3. In embodiments (not shown), the textured portion of the first major surface 104 can include a first plurality of the surface regions 200 arranged in an ordered pattern and a second plurality of the surface regions 200 arranged in a random pattern.

FIG. 4 is a schematic cross-sectional view through a portion of the textured portion of the light-transmitting structure 100 of FIG. 1 showing an embodiment in which the surface regions 200 are configured as domed (convex) surface regions 200a fused with the glass-based substrate 102 to define the light-scattering surface 204 interposed with the first major surface 104. The domed surface regions 200a have a convex shape when viewed facing the first major surface 104, such as in the direction of arrow 206 shown in FIG. 4. The domed surface regions 200a are disposed on the glass-based substrate 102 such that a majority or an entirety of each domed surface region 200a extends above a reference plane 208 defined by the first major surface 104. In embodiments, the reference plane 208 can be a global reference plane derived points taken across an entirety of the first major surface 104. In other embodiments, the reference plane 208 can be a local reference plane derived from points taken proximate to a portion of the domed surface regions 200a. In embodiments, the domed surface regions 200a can also be partially embedded in the glass-based substrate 102 such that a portion (e.g., a relatively small portion) of each domed surface region 200a extends below the reference plane 208, as shown in FIG. 4. In exemplary embodiments, a majority of each domed surface region 200a extends above the reference plane 208. For example, more than 50% (e.g., 55%, 60%, 65%, 70%, 75%, 80%, or more) of each domed surface region 200a (e.g., the portion of the total mass or the total volume of each domed surface region 200a) extends above the reference plane 208.

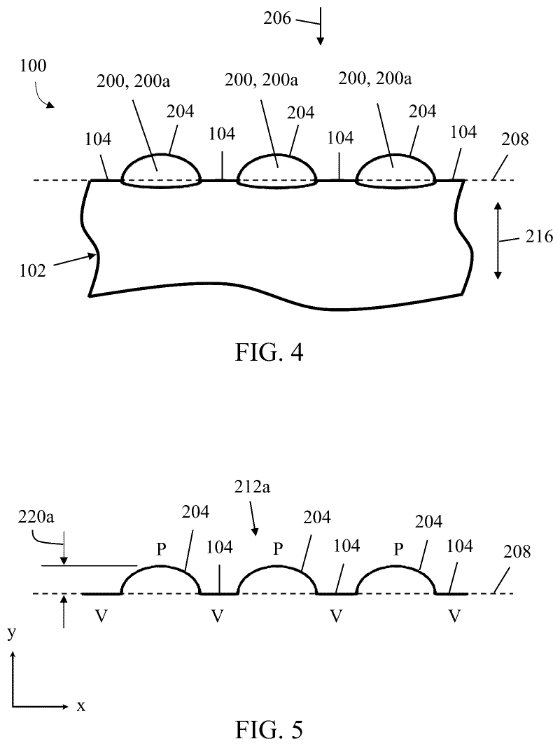

FIG. 5 is a simplified view of the first major surface 104 (associated with the glass-based substrate 102) and the light-scattering surface 204 (associated with the domed surface regions 200a) configured to collectively define a first interface 212a between the light-transmitting structure 100 and an ambient environment to which the light-transmitting structure 100 is exposed (e.g., air). The first interface 212a comprises a plurality of peaks and valleys indicated by numerous instances of the letters P and V, respectively, in FIG. 5. The peaks and valleys occur at points along the cross-section (e.g., the cross-section extends along the x axis) where a curve drawn along the textured portion of the first major surface 104 would have a slope equal to zero when a thickness 216 (FIG. 4) of the light-transmitting structure 100 is shown on the y axis.

Referring now to FIG. 4 and FIG. 5, the domed surface regions 200a define the peaks of the first interface 212a and the first major surface 104 defines the valleys (e.g., along the reference plane 208). The distance between one of the peaks and (an adjacent) one of the valleys (e.g., the peak-to-valley distance 220a) corresponds to a height or depth of each domed surface region 200a. In embodiments, a first average roughness of the first interface 212a comprises a peak-to-valley distance 220a in a range of from about 0.1 μm to about 300 μm, or from about 0.250 μm to about 270 μm, or from about 0.400 μm to about 240 μm, or from about 0.550 μm to about 210 μm, or from about 0.700 μm to about 180 μm, or from about 0.850 μm to about 150 μm, or from about 1 μm to about 120 μm, or from about 0.1 μm to about 260 μm, or from about 0.1 μm to about 220 μm, or from about 0.1 μm to about 180 μm, or from about 0.1 μm to about 140 μm, or from about 0.1 μm to about 100 μm, and comprising all sub-ranges and sub-values between these range endpoints. The height or depth of each domed surface region 200a, or an average height or depth of a group of domed surface regions 200a within a specified area or region, relative to a baselines (e.g., reference plane 208) can be measured using a profilometer and a scan length (e.g., approximately 5 mm).

In embodiments, the surface regions 200 are configured as the domed surface regions 200a, which in turn define the peaks of the first interface 212a, when the second refractive index n₂ is less than the first refractive index n₁ (e.g., n₂<n₁). The second refractive index n₂ can be less than the first refractive index n₁ by at least a minimum difference and at most a maximum difference, such as the minimum and maximum differences previously described. In embodiments that include the domed surface regions 200a, the first refractive index n₁ is in a range of from about 1.40 to about 2.10, or from about 1.45 to about 2.05, or from about 1.50 to about 2.00, or from about 1.55 to about 1.95, or from about 1.60 to about 1.90, or from about 1.65 to about 1.85, or from about 1.70 to about 1.80, and comprising all sub-ranges and sub-values between these range endpoints. In embodiments that include the domed surface regions 200a, the second refractive index n₂ is in a range of from about 1.30 to about 2.00, or from about 1.35 to about 1.95, or from about 1.40 to about 1.90, or from about 1.45 to about 1.85, or from about 1.50 to about 1.80, or from about 1.55 to about 1.75, or from about 1.60 to about 1.70, and comprising all sub-ranges and sub-values between these range endpoints.

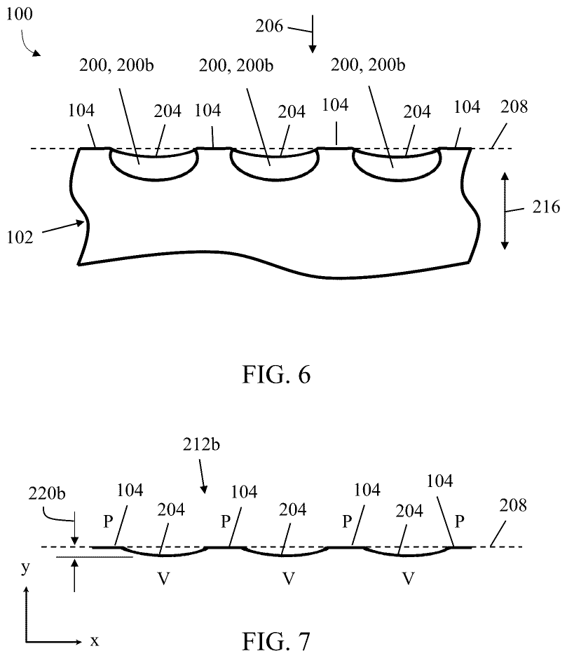

FIG. 6 is a schematic cross-sectional view through a portion of the textured portion of the light-transmitting structure 100 of FIG. 1 showing an embodiment in which the surface regions 200 are configured as collapsed (concave) surface regions 200b fused with the glass-based substrate 102 to define the light-scattering surface 204 interposed with the first major surface 104. The collapsed surface regions 200b each have a concave shape when viewed facing the first major surface 104, such as in the direction of arrow 206 shown in FIG. 6. The collapsed surface regions 200b are embedded in the glass-based substrate 102 such that a majority or an entirety of each collapsed surface region 200b extends below a reference plane 208 defined by the first major surface 104. The reference plane 208 in the embodiment of FIG. 6 can be a global reference plane or a local reference plane such as described with respect to the embodiment of FIG. 4. In embodiments, the collapsed surface regions 200b can also be partially disposed on the glass-based substrate 102 such that a portion (e.g., a relatively small portion) extends above the reference plane 208 (not shown). In exemplary embodiments, a majority of each collapsed surface region 200b extends below the reference plane 208. For example, more than 60% (e.g., 65%, 70%, 75%, 80%, 85%, 90%, or more) of each collapsed surface region 200b (e.g., the portion of the total mass or the total volume of each collapsed surface region 200b) extends below the reference plane 208.

FIG. 7 is a simplified view of the first major surface 104 (associated with the glass-based substrate 102) and the light-scattering surface 204 (associated with the collapsed surface regions 200b) configured to collectively define a second interface 212b between the light-transmitting structure 100 and an ambient environment to which the light-transmitting structure 100 is exposed (e.g., air). The second interface 212b comprises a plurality of peaks and valleys indicated by numerous instances of the letters P and V, respectively, in FIG. 7. The peaks and valleys occur at points along the cross-section (e.g., the cross-section extends along the x axis) where a curve drawn along the textured portion of the first major surface 104 would have a slope equal to zero when a thickness 216 (FIG. 6) of the light-transmitting structure 100 is shown on the y axis.

Referring now to FIG. 6 and FIG. 7, the collapsed surface regions 200b define the valleys of the second interface 212b and the first major surface 104 defines the peaks (e.g., along the reference plane 208). The distance between one of the peaks and (an adjacent) one of the valleys (e.g., the peak-to-valley distance 220b) corresponds to a height or depth of each collapsed surface region 200b. In embodiments, a second average roughness of the second interface 212b comprises a peak-to-valley distance 220b in a range of from about 0.1 μm to about 300 μm, or from about 0.250 μm to about 270 μm, or from about 0.400 μm to about 240 μm, or from about 0.550 μm to about 210 μm, or from about 0.700 μm to about 180 μm, or from about 0.850 μm to about 150 μm, or from about 1 μm to about 120 μm, or from about 0.1 μm to about 260 μm, or from about 0.1 μm to about 220 μm, or from about 0.1 μm to about 180 μm, or from about 0.1 μm to about 140 μm, or from about 0.1 μm to about 100 μm, and comprising all sub-ranges and sub-values between these range endpoints. The height or depth of each collapsed surface region 200b, or an average height or depth of a group of collapsed surface regions 200b within a specified area or region, relative to a baseline (e.g., reference plane 208) can be measured using a profilometer and a scan length (e.g., approximately 5 mm).

In embodiments, the surface regions 200 are configured as the collapsed surface regions 200b, which in turn define the valleys of the second interface 212b, when the second refractive index n₂ is greater than the first refractive index n₁ (e.g., n₂>n₁). The second refractive index n₂ can be greater than the first refractive index n₁ by at least a minimum difference and at most a maximum difference, such as the minimum and maximum differences previously described. In embodiments that include the collapsed surface regions 200b, the first refractive index n₁ is in a range of from about 1.35 to about 1.95, or from about 1.40 to about 1.900, or from about 1.45 to about 1.85, or from about 1.50 to about 1.80, or from about 1.55 to about 1.75, or from about 1.60 to about 1.70, and comprising all sub-ranges and sub-values between these range endpoints. In embodiments that include the collapsed surface regions 200b, the second refractive index n₂ is in a range of from about 1.50 to about 2.10, or from about 1.55 to about 2.05, or from about 1.60 to about 2.00, or from about 1.65 to about 1.95, or from about 1.70 to about 1.90, or from about 1.75 to about 1.85, and comprising all sub-ranges and sub-values between these range endpoints.

In embodiments, some of the surface regions 200 fused with the glass-based substrate 102 can differ from other surface regions 200 fused with the glass-based substrate 102 relative to the same or different surfaces thereof. For example, the light-transmitting structure 100 can include a first plurality of the surface regions 200 and a second plurality of the surface regions 200 both disposed relative to the first major surface 104. In embodiments the first and second pluralities of the surface regions 200 can both be configured as the domed surface regions 200a or the collapsed surface regions 200b. In either case, the first and second pluralities of the surface regions 200 can differ with respect to the height or depth of the surface regions, such that the first plurality of surface regions has a height or depth that is smaller than a height or depth of the second plurality of surface regions. For example, the first plurality of surface regions can have peak-to-valley distance in a range of from about 0.1 μm to less than about 150 μm and the second plurality of surface regions can have a peak-to-valley distance in a range of from equal to about 150 μm to about 300 μm.

In embodiments in which the first and second pluralities of the surface regions 200 are both configured as the domed surface regions 200a or the collapsed surface regions 200b, the first and second pluralities of the surface regions 200 can differ with respect to other physical attributes, such as composition, refractive index, feature size or width (e.g., maximum or average dimension parallel to the first major surface 104), portion of extent above or below the reference plane, and other physical attributes. In embodiments, compositions are “different” when the identity, arrangement, and/or ratio of the elements making up the compositions differ (e.g., differ by a measurable or otherwise detectable attribute). In embodiments, the first and second pluralities of surface regions 200 can differ with respect to configuration as domed surface regions or collapsed surface regions. For example, the first plurality of surface regions can be configured as the domed surface regions 200a, and the second plurality of surface regions can be configured as the collapsed surface regions 200b.

The surface regions 200 disclosed herein form microstructures with AG properties and change the local refractive index at microns to tens of microns dimensions. In other words, the surface regions 200 co-locate the AG features and the index changes relative to the glass-based substrate 102. Without being bound by theory, it is believed that by introducing co-located AG features and index changes into the glass-based substrate 102, the distinctness-of-image (DOI) and the sparkle of the glass-based substrate 102 can be concurrently lowered. As such, it is believed that introducing surface regions as described herein (e.g., domed surface regions 200a and/or collapsed surface regions 200b with different compositions and different refractive indices compared to the glass-based substrate) may allow for improvements in both the DOI and the sparkle of the glass-based substrate 102 and accordingly the DOI and the sparkle of the light-transmitting structure 100. It is similarly believed that by introducing surface regions as described herein, the glass-based substrate 102 may have comparatively better optical parameters, such as DOI and sparkle, when compared to textured substrates that do not have the surface regions described herein.

The textured portion of the light-transmitting structure 100 can have specific optical parameters, such as coupled DOI and sparkle. For example, the textured light-transmitting structure 100 can be characterized by sparkle. “Sparkle,” “sparkle contrast,” “display sparkle,” “pixel power deviation,” “PPD,” or like terms refers to the visual phenomenon that occurs when a textured transparent surface is combined with a pixelated display. Generally speaking, quantitation of sparkle involves imaging a lit display or simulated display with the textured surface in the field of view. The calculation of sparkle for an area P is equal to σ(P)/μ(P), where σ(P) is the standard deviation of the distribution of integrated intensity for each display pixel contained within area P divided by the mean intensity μ(P). Following the guidance in: (1) J. Gollier, et al., “Apparatus and method for determining sparkle,” U.S. Pat. No. 9,411,180B2, United States Patent and Trademark Office, 20 Jul. 2016; (2) A. Stillwell, et al., “Perception of Sparkle in Anti-Glare Display Screens,” JSID 22 (2), 129-136 (2014); and (3) C. Cecala, et al., “Fourier Optics Modeling of Display Sparkle from Anti-Glare Cover Glass: Comparison to Experimental Data”, Optical Society of America Imaging and Applied Optics Congress, JW5B.8 (2020); one skilled in the art can build an imaging system to quantify sparkle. Alternatively, a commercially available system (e.g., the SMS-1000, Display Messtechnik & Systeme Gmbh & Co. KG, Germany) can also be used.

As described herein, sparkle is measured with a 140 PPI display. A 140 PPI display (e.g., Z50, Lenovo Group Limited, Hong Kong) with only the green subpixels lit (R=0, B=0, G=255), at full display brightness is imaged using a f=50 mm lens/machine vision camera combination (e.g., C220503 1:2.8 50 mm @30.5, Tamron, Japan) and Stingray F-125 B, Allied Vision Technologies GmbH, Germany). The lens settings are aperture=5.6, depth of field=0.3, working distance=about 290 mm; with these settings, the ratio of display pixels to camera pixels is approximately 1 to 9. The field of view for analysis contains approximately 7500 display pixels. Camera settings have the gain and gamma correction turned off. Periodic intensity variations from, e.g., the display, and non-periodic intensity variations, e.g., dead pixels, are removed during analysis prior to the calculation of sparkle.

In embodiments, the textured portion of the light-transmitting structure 100 can have a sparkle at 140 PPI of less than or equal to 3%. For example, in embodiments, the textured portion of the light-transmitting structure 100 can have a sparkle at 140 PPI of less than or equal to 2%, less than or equal to 1.9%, less than or equal to 1.8%, less than or equal to 1.7%, less than or equal to 1.6%, less than or equal to 1.5%, less than or equal to 1.4%, less than or equal to 1.3%, less than or equal to 1.2%, less than or equal to 1.1%, or even less than or equal to 1.0%.

The textured light-transmitting structure 100 described herein can further be characterized by distinctness-of-image. “Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{{R}_{OS}}{{R}_{S}} ] \times 100 \qquad ( 1 )$$

Where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of ±0.05° centered on the specular direction. Both Rs and Ros were measured using a goniophotometer (Rhopoint Instruments) that is calibrated to a certified black glass standard, as specified in ASTM procedures D523 and D5767. The goniophotometer uses a detector array in which the specular angle is centered about the highest value in the detector array. DOI was also evaluated using 1-side (black absorber coupled to rear of glass) method. The 1-side measurement allows the gloss, reflectance, and DOI to be determined for a single surface (e.g., a single roughened surface) of the glass article. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767. The scale value obtained with the measuring procedures of ASTM D5767 range from 0 to 100 with a value of 100 representing perfect DOI (image clarity).

In embodiments, the textured portion of the light-transmitting structure 100 can have a coupled DOI of less than 60%. For example, in embodiments, the textured portion of the light-transmitting structure 100 can have a coupled DOI of less than 55%, less than 50%, less than 45%, less than 40%, less than 35%, less than 30%, less than 25%, less than 20%, less than 15%, less than 10%, or even less than 5%.

The first composition of the glass-based substrate 102 and the second composition of the surface regions 200 can comprise any suitable compositions and be made using any suitable method provided the compositions are transparent and possess the refractive index relationships disclosed herein. As used herein, the term “transparent” is intended to mean that the first and second compositions each have an optical transmission of greater than about 80% (e.g., over a length of about 0.5 mm) in the visible region of the spectrum (e.g., from about 380 nm to about 770 nm). For instance, an exemplary transparent composition may have greater than about 85% transmittance in the visible light range, such as greater than about 89%, greater than about 90%, greater than about 95%, or greater than about 99% transmittance, including all ranges and subranges therebetween.

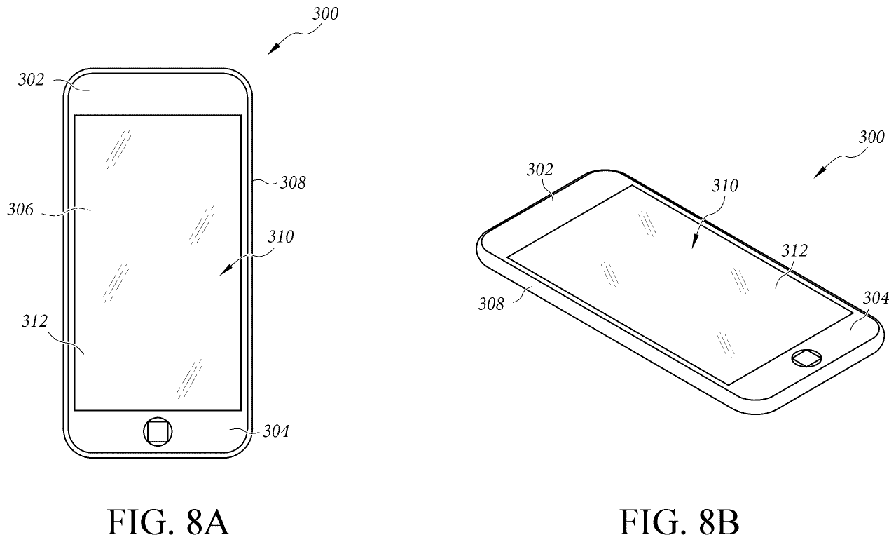

The textured light-transmitting structure 100 disclosed herein, as-formed or following ion exchange, can be incorporated into another article such as an article with a display or display articles (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating the textured light-transmitting structure disclosed herein is shown in FIG. 8A and FIG. 8B. Specifically, FIG. 8A and FIG. 8B show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover substrate 312 at or over the front surface of the housing such that it is over the display. In embodiments, at least a portion of at least one of the cover substrate 312 and/or the housing 302 can include the textured light-transmitting structure disclosed herein.

A method for forming a light-transmitting structure is now disclosed. The method is described with reference to the light-transmitting structure 100 of FIGS. 1-7 to facilitate a better understanding of the different aspects of the method. The method includes applying a coating comprising a plurality of particles to a first major surface 104 of a glass-based substrate 102. In embodiments, the glass-based substrate 102 comprises a first composition that is transparent and has a first refractive index n₁. In embodiments, the particles each comprise a second composition that is transparent and has a second refractive index n₂ that is different than the first refractive index n₁.

In embodiments, the particles are fine particles with a particle size in a range of from about 0.10 μm to about 150 μm, or from about 0.90 μm to about 120 μm, or from about 1.70 μm to about 90 μm, or from about 2.5 μm to about 60 μm, or from about 3.3 μm to about 30 μm, or from about 0.10 μm to about 127.5 μm, or from about 0.10 μm to about 105 μm, or from about 0.10 μm to about 82.5 μm, or from about 0.10 μm to about 75 μm, or from about 0.10 μm to about 60 μm, or from about 0.10 μm to about 37.5 μm, or from about 0.10 μm to about 15 μm, and comprising all sub-ranges and sub-values between these range endpoints.

The method further includes irradiating the coating and the glass-based substrate 102 with a beam from a laser to fuse the particles with the glass-based substrate 102. The fused particles form a plurality of surface regions 200, 200a, 200b configured to define a light-scattering surface 204 interposed with the first major surface 104. The first major surface 104 and the light-scattering surface 104 define an interface 212a, 212b to an ambient environment (e.g., air).

In embodiments, the first refractive index n₁ and the second refractive index n₂ can have the minimum difference and/or the maximum difference previously described with reference to FIGS. 1-7. In embodiments, the interface 212a, 212b comprises a plurality of peaks and valleys. The interface 212a, 212b can have an average roughness that comprises a peak-to-valley distance 220a, 220b in the range previously described with reference to FIGS. 4-7.

In embodiments, the method can include forming the surface regions 200 as one or more of domed (convex) surface regions 200a and collapsed (concave) surface regions 200b. If the domed surface regions 200a are formed, the method comprises selecting the first composition of the glass-based substrate 102 and the second composition of each of the particles such that the second refractive index n₂ is less than the first refractive index n₁ (e.g., n₂<n₁). When a portion of the first major surface 104 has this refractive index relationship between the coating and the glass-based substrate 102 prior to the irradiating, the surface regions 200 are formed as the domed surface regions 200a and define the peaks of a first interface 212a after the irradiating.

If the collapsed surface regions 200b are formed, the method comprises selecting the first composition of the glass-based substrate 102 and the second composition of each of the particles such that the second refractive index n₂ is greater than the first refractive index n (e.g., n₂>n₁). When a portion of the first major surface 104 has this refractive index relationship between the coating and the glass-based substrate 102 prior to the irradiating, the surface regions 200 are formed as the collapsed surface regions 200b and define the valleys of a second interface 212b after the irradiating. It should be appreciated that different coatings having particles with different compositions and refractive indices can be used to form the one or more of the domed surface regions 200a and the collapsed surface regions 200b relative to different portions of the first major surface 104.

In embodiments, applying the coating to the first major surface includes mixing the particles with a liquid to form a slurry, applying the slurry to the first major surface, and drying the slurry to remove the liquid and leave the particles adhered to the first major surface. Further aspects of the coating are described in the Examples section of this disclosure.

In embodiments, irradiating the coating and the glass-based substrate with the beam from the laser comprises heating the coating and the glass-based substrate 102 to a temperature at or above the working points (e.g., the temperature corresponding to the viscosity of 10⁴ P) of the first composition of the glass-based substrate 102 and the second composition of the particles of the coating.

In embodiments, irradiating the coating and the glass-based substrate causes a portion of the first composition of the glass-based substrate 102 and a portion of the second composition of the particles proximate the irradiation to have one or more of composition-related changes (e.g., interdiffusion), to have phase-related changes, and/or volumetric-related changes (e.g., due laser-induced ablation). In embodiments, the laser is a carbon monoxide (CO) laser or a carbon dioxide (CO₂) laser.

In embodiments, the irradiating comprises setting one or more parameters of the laser. The parameters can include a laser type, a center wavelength, a repetition rate, an average power, a pulse duration or pulse length, a dwell time between multiple pulses, a pulse energy, a beam shape, a beam size (e.g., diameter), a focal length, a spot size, a scanning method, a scanning speed, a scanning pitch spacing, a scanning line spacing, a laser fluence, as well as other parameters.

In embodiments, the beam can have a diameter in a range of from about 50 μm to about 1000 μm, or from about 75 μm to about 750 μm, or from about 100 μm to about 500 μm. In embodiments, the pulse length is in a range of from about 1 μs to about 10000 μs, or from about 5 μs to about 5000 μs, or from about 10 μs to about 1000 μs. In embodiments, the dwell time is in a range of from about 0.001 ms to about 10 ms, or from about 0.01 ms to about 8 ms, or from about 0.1 ms to about 5 ms.

Details of the one or more parameters, including the settings thereof, are described in the Examples section of this disclosure.

In embodiments, the method further comprises preheating the glass-based substrate 102 and the coating to a preheat temperature prior to the irradiating. The pre-heat temperature can be in a range of from about 200° C. to about 600° C.

### EXAMPLES

Various embodiments of the present disclosure can be better understood by reference to the following Examples which are offered by way of illustration. The present disclosure is not limited to the Examples given herein.

### Example 1—Sample Preparation

Multiple glass-based compositions were combined in different coating/substrate pairs in the Examples to illustrate fabrication of light-transmitting structures from CO₂ laser processing. Table 1 lists the chemical constituents and select physical properties for three glass compositions, e.g., Composition 1 (C1), Composition 2 (C2), and Composition 3 (C3), used in the Examples. The chemical constituents are expressed in terms of weight percent on an oxide basis, density is reported in g/cm3 at room temperature, average coefficient of linear thermal expansion (CTE) is reported in terms of ×10⁻⁷/° C. between 0° C. and 300° C., and Refractive Index (Index) is reported at λ=546 nm.

TABLE 1

| | Composition No. | | |
|---|---|---|---|
| | C1 | C2 | C3 |
| Composition [wt %] | | | |
| SiO₂ | 74.04 | 28.68 | 7.6 |
| B₂O₃ | — | 2 | 16.5 |
| Al₂O₃ | 7.6 | — | — |
| P₂O₅ | 2.11 | — | 1 |
| Li₂O | 11.5 | 4 | — |
| CaO | — | 15.25 | 12.6 |
| SnO₂ | 0.22 | — | — |
| ZrO₂ | 4.24 | 5.5 | 8.2 |
| TiO₂ | — | 8.78 | 9.4 |
| Nb₂O₅ | — | 15 | 18 |
| La₂O₃ | — | 20.8 | 27.6 |
| Physical Properties | | | |
| Density [g/cm³ @ RT] | 2.414 | 3.65 | 4.03 |
| CTE [×10⁻⁷/° C. at 0-300° C.] | 72.7 | 91 | 75 |
| Refractive Index [λ = 546 nm] | 1.54 | 1.8 | 1.9 |

Several coating/substrate pairs (e.g., coating on substrate) were prepared and treated with the CO₂ laser, including C1 coating on C2 substrate (Sample 1), C3 coating on C2 substrate (Sample 2), and C2 coating on C1 substrate (Sample 3). The same procedure was used to prepare coating/substrate pairs according to Sample 1 and Sample 3. An objective of the sample preparation was to create a cullet slurry that can be coated and dried on a glass substrate for subsequent laser processing.

Preliminary testing was used to develop procedures for preparing the cullet slurry, coating the substrate, and drying the coated substrate. The substrates on which the coatings were applied were thin glass squares with a size of 2″×2″×0.028″. The glass cullet used to prepare the cullet slurry were made by crushing and grounding a selected composition of glass. Through glass crushing, cullet powder was isolated into the following particle sizes via sieving (mesh number(s) indicated parenthetically): +149 μm (+100 mesh), 149 μm−74 μm (−100 mesh/+200 mesh), 74 μm−25 μm (−200 mesh/+500 mesh), and −25 μm (−500 mesh). Preliminary testing was performed with all particle size ranges. From this preliminary testing, it was observed that cullet powder isolated from finest mesh (e.g., −500 mesh) provided a favorable slurry.

Cullet powder isolated from the −500 mesh (e.g., −25 μm particles) was used to develop a coating procedure for the coating/substrate pairs according to Sample 1 and Sample 3. A brush was used to apply the coating to the substrate. The brush method was sufficient for proof-of-concept testing although coating uniformity may be improved via other coating methods. Coating uniformity may also be improved via organic binders. However, the use of such organic binders may result in burnout during laser treatment, which may require additional safety measures. Various coating methods may be used, including screen coating, spray-coating, roll coating, tape casting, or spin coating. The coating method can be selected based on slurry viscosity, coating thickness, and uniformity issues.

A preferred mix for the slurry was selected to include −500 mesh glass powder dispersed in water. Thereafter, different cullet-to-water ratios were prepared to further evaluate the coating. From this preliminary testing, an exemplary procedure was developed to prepare the cullet slurry, apply the coating to the sample substrates, and dry the coated sample substrates. In the following description of the exemplary procedure, “Glass A” refers to the composition of the coating and “Glass B” refers to the composition of the substrate. Glass A can be any one of compositions C1, C2, and C3, and Glass B can be a different one of compositions C1, C2, and C3.

As a first step of the exemplary procedure, 1 g of −500 mesh Glass A cullet powder and 10 g of deionized (DI) water (as solvent) are measured. As a second step, the measured DI water and the measured cullet powder are poured into a bottle. A lid is screwed onto the bottle and the bottle is manually shaken for approximately 2 minutes until the liquid is a uniform, milky color to form a slurry. As a third step, a brush is dipped into the slurry and applied over the top surface of the 2″×2″×0.028″ Glass B substrate. A single layer/coating of the Glass A slurry is applied to completely cover the top surface of the Glass B substrate. As a fourth step, the coated substrate is then placed in a drying furnace at 100° C. for about 24 hours. After about 24 hours, the substrate is removed from the drying furnace. The water solvent is completed evaporated leaving the Glass A cullet powder adhered to the top surface of the Glass B substrate. The sample is then prepared for laser processing.

### Example 2—Laser Processing

In this example, the fusing of a thin coating of glass particles on a glass substrate required heating of both the glass particles and the glass substrate to a temperature at or above the working points of the glasses. High-power carbon monoxide (CO) lasers (e.g., operating at a wavelength of about 5.6 μm) and high-power carbon dioxide (CO₂) lasers (e.g., operating at wavelengths in a range of from about 9.2 μm to about 11.2 μm) are exemplary laser sources for such heating due to the strong absorption of silicate glasses in the far-infrared range, which can be used to promote interdiffusion of the glass coating and the glass substrate.

In one approach, thin-coated glass substrates are heated with a round laser beam with Gaussian intensity distribution. The round laser beam can have a diameter of several hundreds of microns. One or more laser pulses are used to heat the glass particles and the glass substrate to a temperature at or above the working points of the glasses. With the reduced glass viscosity due to heating, fusing and intermixing of the glass particles and the glass substrate occurs. Since thermal conduction in glass is slow, long pulse CO or CO₂ lasers can be used.

Preheating of the thin-coated glass substrates prior to laser fusing is beneficial since it can reduce localized transient and residual thermal stress caused by the rapid laser heating process. In one example, thin-coated glass substrates were preheated to a temperature of about 600° C. The laser beam diameter on the glass substrates was about 0.4 mm. At targeted locations, two laser pulses of 15 μs pulse length and separated by 1 ms were used to heat the glass particles and the glass substrates. The pulse energy of the CO₂ laser was 9.9 mJ.

### Example 3—Analysis of Sample 2-1

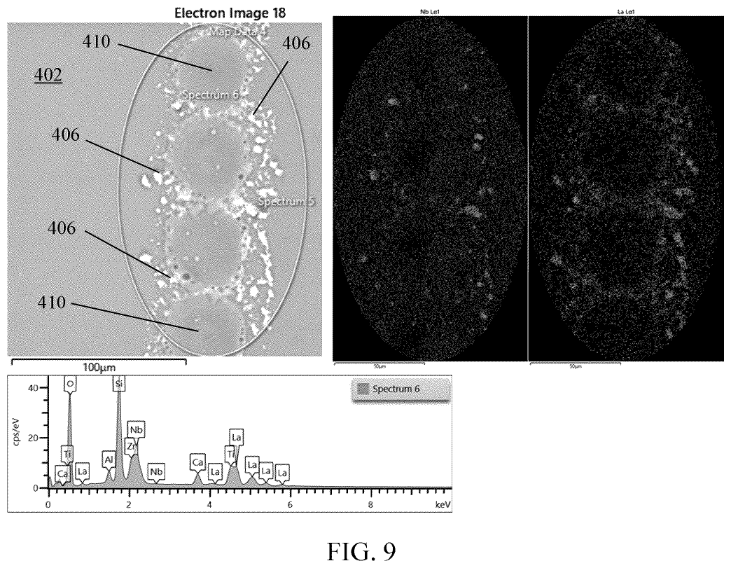

Several samples were prepared according to Example 1 and laser processed according to Example 2 to illustrate the local fusion and special morphologies discussed throughout this disclosure. A coating/substrate pair sample according to Sample 2 (e.g., C3 coating on C2 substrate) (hereinafter “Sample 2-1”) was laser processed to illustrate proof of concept. The laser parameters and processing conditions for Sample 2-1 included: laser type=CO₂ laser; operating wavelength=9.3 μm; frequency=3 kHz; average power=0.54 W; and preheat temperature=300° C. FIG. 9 (top left) is a scanning electron microscope (SEM) image of a portion of Sample 2-1, and FIG. 9 (top right) are energy dispersive spectrometry (EDS) elemental mapping images of the area circled in the SEM image. The images of FIG. 9 confirm the heat effect from CO₂ laser processing can cause local glass melting and fusion of the C3 coating (generally indicated by 406) on the C2 substrate (generally indicted by 402). The laser parameters can be adjusted to reduce ablation and prevent and/or minimize voids (generally indicated by 410).

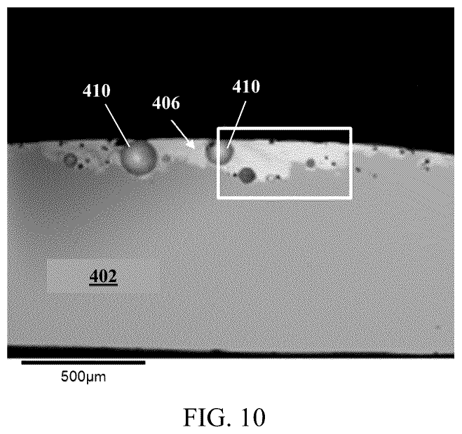

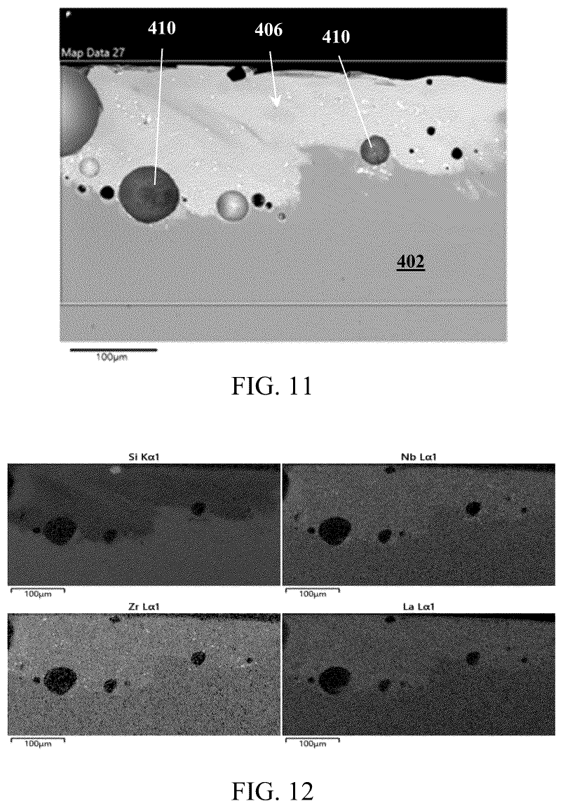

FIG. 10 is a backscattered electron (BSE) image of a cross section of Sample 2-1 showing fusion of the C3 coating 406 on the C2 substrate 402. FIG. 11 is an enlarged view of the area enclosed by the white rectangle in FIG. 10. FIG. 12 are EDS elemental mapping images of the area shown in FIG. 11. The images of FIGS. 10-12 show significant local mixing and melting across the interface of Sample 2-1, confirming the fusion of the C3 coating 406 on the C2 substrate 402 after CO₂ laser processing. In particular, the images of FIG. 11 and FIG. 12 show significant chemistry interdiffusion. The laser parameters can be adjusted for less rigorous reaction to prevent voids 410.

### Example 4—Analysis of Sample 3-1

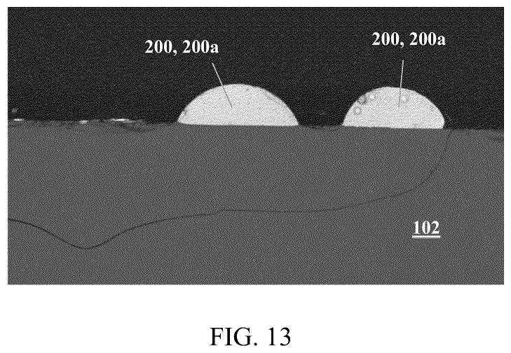

A coating/substrate pair sample according to Sample 3 (e.g., C2 coating on C1 substrate) (hereinafter “Sample 3-1”) was laser processed to illustrate the formation of domed surface regions 200a as discussed previously with reference to FIG. 4 and FIG. 5. The domed surface regions 200a, as shown in FIG. 13, are formed from the C2 composition and the glass-based substrate 102 is formed from the C1 composition. The laser parameters and processing conditions for Sample 3-1 included: laser type=CO₂ laser; operating wavelength=10.6 μm; average power=260 W; and preheat temperature=400° C.

### Example 5—Analysis of Sample 1-1

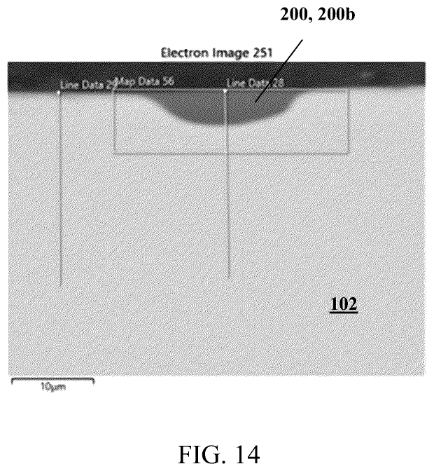

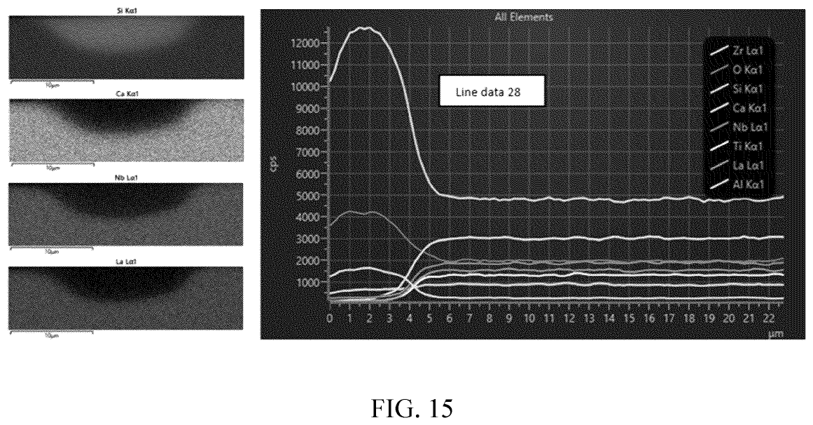

A coating/substrate pair sample according to Sample 1 (e.g., C1 coating on C2 substrate) (hereinafter “Sample 1-1”) was laser processed to illustrate the formation of collapsed surface regions 200b as discussed previously with reference to FIG. 6 and FIG. 7. The collapsed surface regions 200b, as shown in FIG. 14, are formed from the C1 composition and the glass-based substrate 102 is formed from the C2 composition. The laser parameters and processing conditions for Sample 1-1 included: laser type=CO₂ laser; operating wavelength=10.6 μm; average power=260 W; and preheat temperature=400° C. FIG. 15 (left) are EDS elemental mapping images of the area proximate the collapsed surface region 200b shown in FIG. 14. FIG. 15 (right) is a chart plotting the elemental concentrations associated with the respective EDS images of FIG. 15 (left). The images of FIG. 14 and FIG. 15 show significant local mixing and melting across the interface of Sample 1-1, confirming significant chemistry interdiffusion.

In embodiments not depicted in the Examples, the laser type and corresponding laser wavelength can be selected based on the thickness of the coating applied to the glass-based substrate. For example, if the thickness of the coating is in a range of tens of microns or less, a CO₂ laser operating at 9.3 μm, 10.6 μm, or 11.2 μm, or a CO laser operating at 5.6 μm can be used to perform the laser processing. However, if the thickness of the coating is in a range of tens of microns or more, a CO laser may be better suited to perform the laser processing due to the deeper penetration depth of the CO laser.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A light-transmitting structure, comprising:
a glass-based substrate having a first major surface and a second major surface opposite the first major surface, the glass-based substrate comprising a first composition that is transparent and has a first refractive index n₁; and
a plurality of surface regions fused with the glass-based substrate to define a light-scattering surface interposed with the first major surface, each surface region comprising a second composition that is transparent and has a second refractive index n₂ that is different than the first refractive index n₁, the first major surface and the light-scattering surface defining an interface to an ambient environment.

2. The light-transmitting structure of claim 1, wherein |n₂−n₁|≥0.05.

3. The light-transmitting structure of claim 1, wherein the interface comprises a plurality of peaks and valleys, and wherein an average roughness of the interface comprises a peak-to-valley distance in a range of from about 0.1 μm to about 300 μm.

4. The light-transmitting structure of claim 1, wherein the surface regions define the peaks when n₂<n₁.

5. The light-transmitting structure of claim 4, wherein the first refractive index n₁ is in a range of from about 1.40 to about 2.10.

6. The light-transmitting structure of claim 4, wherein the second refractive index n₂ is in a range of from about 1.30 to about 2.00.

7. The light-transmitting structure of claim 4, wherein the surface regions define the valleys when n₂>n₁

8. The light-transmitting structure of claim 7, wherein the first refractive index n is in a range of from about 1.4 to about 1.9.

9. The light-transmitting structure of claim 7, wherein the second refractive index n₂ is in a range of from about 1.5 to about 2.1.

10. The light-transmitting structure of claim 1, wherein the second composition is a glass.

11. The light-transmitting structure of claim 1, wherein the second composition is a metal, a metal oxide, or a combination thereof.

12. The light-transmitting structure of claim 1, wherein the second composition is a polymer.

13. A method for forming a light-transmitting structure, comprising:
applying a coating comprising a plurality of particles to a first major surface of a glass-based substrate, the glass-based substrate comprising a first composition that is transparent and has a first refractive index n₁, the particles each comprising a second composition that is transparent and has a second refractive index n₂ that is different than the first refractive index n₁; and
irradiating the coating and the glass-based substrate with a beam from a laser to fuse the particles with the glass-based substrate, the fused particles forming a plurality of surface regions configured to define a light-scattering surface interposed with the first major surface, the first major surface and the light-scattering surface defining an interface to an ambient environment.

14. The method of claim 13, wherein |n₂−n₁|≥0.05.

15. The method of claim 13, wherein the interface comprises a plurality of peaks and valleys, and wherein an average roughness of the interface comprises a peak-to-valley distance in a range of from 0.1 μm to 300 μm.

16. The method of claim 15, further comprising:
selecting the first composition and the second composition to have n₂<n₁ such that the surface regions define the peaks after the irradiating, or
selecting the first composition and the second composition to have n₂>n₁ such that the surface regions define the valleys after the irradiating.

17. The method of any claim 13, wherein one or more of:
applying the coating to the first major surface comprises:
mixing the particles with a liquid to form a slurry;
applying the slurry to the first major surface; and
drying the slurry to remove the liquid and leave the particles adhered to the first major surface; and
a particle size of the particles is in a range of from about 0.10 μm to about 150 μm.

18. The method of claim 13, wherein one or more of:
the beam is configured to have a Gaussian intensity distribution, and
the beam has a diameter in a range of from about 50 μm to about 1000 μm.

19. The method of claim 13, wherein the irradiating comprises directing a focus of the beam at a target location for multiple pulses with each pulse having a pulse length and with a dwell time between each pulse, and one or more of (i) the pulse length is in a range of from about 1 μs to about 10000 μs and (ii) the dwell time is in a range of from about 0.1 ms to about 5 ms.

20. The method of claim 13, wherein the laser is a CO laser or a CO₂ laser.

21. The method of claim 13, further comprising preheating the glass-based substrate and the coating to a preheat temperature prior to the irradiating, and wherein the preheating is in a range of from about 200° C. to about 600° C.
